(19) United States
(12) Patent Application Publication
(10) Pub. No.: US 2013/0272525 A1
(43) Pub. Date: Oct. 17, 2013

(54) APPARATUS AND METHOD FOR PROVIDING AUDIO METADATA, APPARATUS AND METHOD FOR PROVIDING AUDIO DATA, AND APPARATUS AND METHOD FOR REPRODUCING AUDIO DATA

(71) Applicant: ELECTRONICS AND TELECOMMUNICATIONS RESEARCH INSTITUTE, Daejeon (KR)

(72) Inventors: Jae Hyoun YOO, Daejeon (KR); Jeong Il SEO, Daejeon (KR); Tae Jin LEE, Daejeon (KR); Kyeong Ok KANG, Daejeon (KR)

(73) Assignee: Electronics and Telecommunications Research Institute, Daejeon (KR)

(21) Appl. No.: 13/846,726

(22) Filed: Mar. 18, 2013

(30) Foreign Application Priority Data
Apr. 13, 2012 (KR) 10-2012-0038407

(51) Int. Cl. H04S 7/00

(52) U.S. Cl. CPC H04S 7/30
USPC 381/1

(57) ABSTRACT

An apparatus for providing audio metadata, the apparatus including an audio data generating unit to generate audio metadata including channel information of raw audio data, and an audio metadata transmitting unit to transmit the generated audio metadata to an apparatus for reproducing audio data.

### CROSS-REFERENCE TO RELATED APPLICATION

This application claims the priority benefit of Korean Patent Application No. 10-2012-0038407, filed on Apr. 13, 2012, in the Korean Intellectual Property Office, the disclosure of which is incorporated herein by reference.

### BACKGROUND

1. Field of the Invention

The present invention relates to a method for generating audio data including a multi channel, and providing the generated audio data to an apparatus for reproducing audio data, and more particularly, to a method for representing audio data of the multi channel using metadata including audio signal channel information.

2. Description of the Related Art

Information on a number of signals configuring audio content, and a location at which a channel is to be disposed spatially may be required to embody audio data as a multi channel. Existing 5.1 channel audio data may have a condition in which a total of six signals are produced and reproduced at locations of “0” degrees, “+30” degrees, “+110” degrees, “+250” degrees, “+330” degrees, and a “null” degree.

Ultra high definition television (UHDTV) technology is being developed, and research into a method for reproducing more realistic audio that uses a greater number of speakers than the 5.1 channel provided by a high definition television (HDTV) is garnering attention.

With regard to a method for representing audio data including a conventional multi channel, when a plurality of outputs is added in a multi channel audio system, Korean Patent Registration No. 10-0522593 suggests a method for implementing a multi channel audio in which the added plurality of outputs is generated to be harmonious with an existing multi channel audio, and implements natural three-dimensional (3D) sound.

More particularly, the method for implementing the multi channel audio may include decoding by receiving an input of an encoded audio stream, and generating 3D sound of multi channel, using the decoded audio stream. Subsequently, the method for implementing the multi channel audio may provide a multi channel audio by generating a television left speaker output and a television right speaker output using a left stereo channel signal, a right stereo channel signal, and a center channel signal in the generated multi channel sound output.

However, a conventional method for implementing a multi channel audio may describe a configuration of converting 5.1 channel audio data to 7.1 channel audio data, and have an issue in that various types of audio channel system configurations may be difficult.

Also, although several schemes such as a current Auro 3D, T.Holman 12.2 (10.2) channel, and the like, may represent an audio channel independently by disposing at least six speakers on a horizontal plane, an additional system, for example, an audio/video (A/V) receiver, and the like, may be essential.

Accordingly, there is a desire for technology of representing audio data including a multi channel in various manners.

### SUMMARY

An aspect of the present invention provides an apparatus for generating audio metadata that generates audio metadata including channel information of raw audio data, and transmits the generated audio metadata to an apparatus for reproducing audio data.

Another aspect of the present invention also provides an apparatus for providing audio data that combines raw audio data and audio metadata including raw audio data channel information, and outputs multi-channel audio in various manners by transmitting the combined raw audio data and the audio metadata to an apparatus for reproducing audio data.

Another aspect of the present invention also provides an apparatus for reproducing audio data that reproduces raw audio data based on audio metadata by demultiplexing or decoding audio data received from an apparatus for providing audio data.

Another aspect of the present invention also provides an apparatus for reproducing audio data that enables a channel compatibility through combining a signal of an audio channel included in raw audio data when a channel included in audio reproducing setting information is a lower channel than a channel included in the raw audio data.

According to an aspect of the present invention, there is provided an apparatus for providing audio metadata, the apparatus including an audio metadata generating unit to generate audio metadata including channel information of raw audio data, and an audio metadata transmitting unit to transmit the generated audio metadata to an apparatus for reproducing audio data.

According to an aspect of the present invention, there is provided an apparatus for providing audio data, the apparatus including an audio metadata generating unit to generate audio metadata including channel information of raw audio data, an audio data combining unit to combine the raw audio data and the generated audio metadata to audio data, and an audio data transmitting unit to transmit the combined audio data to an apparatus for reproducing audio data.

According to an aspect of the present invention, there is provided an apparatus for reproducing audio data, the apparatus including an audio data receiving unit to receive audio data from an apparatus for providing audio data, an audio data analyzing unit to analyze raw audio data and audio metadata from the received audio data, and an audio data reproducing unit to reproduce the raw audio data based on the analyzed audio metadata and predetermined audio reproducing setting information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of audio data according to an embodiment of the present invention;

FIG. 2 is a diagram illustrating an operation of an apparatus for providing audio metadata transmitting audio metadata to an apparatus for reproducing audio data according to an embodiment of the present invention;

FIG. 3 is a diagram illustrating an operation of an apparatus for providing audio data transmitting audio metadata to an apparatus for reproducing audio data according to an embodiment of the present invention;

FIG. 4 is a diagram illustrating a configuration of audio metadata according to an embodiment of the present invention;

FIG. 5 is a diagram illustrating an example of an audio metadata configuration according to an embodiment of the present invention;

FIG. 6 is a diagram illustrating a standard of audio channel location information according to an embodiment of the present invention;

FIG. 7 is a diagram illustrating speakers being disposed in space based on audio channel location information according to an embodiment of the present invention;

FIG. 8 is a diagram illustrating another embodiment of an audio metadata configuration according to an embodiment of the present invention;

FIG. 9 is a flowchart illustrating an operation in which an apparatus for providing audio metadata provides audio metadata according to an embodiment of the present invention;

FIG. 10 is a flowchart illustrating an operation in which an apparatus for providing audio data provides audio data according to an embodiment of the present invention; and

FIG. 11 is a flowchart illustrating an operation in which an apparatus for reproducing audio data reproduces audio data according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

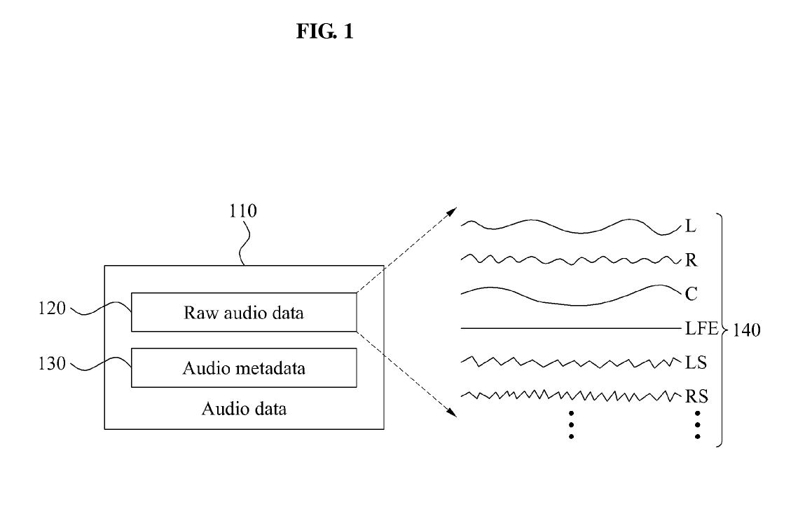

FIG. 1 is a diagram illustrating a configuration of audio data 110 according to an embodiment of the present invention.

Referring to FIG. 1, the audio data 110 may include raw audio data 120 and audio metadata 130. The raw audio data 120 may refer to an audio signal, and include a number of the audio signal corresponding to a number of channels. The raw audio data 120 may store a generated audio signal sequentially. For example, the audio data 110 of 5.1 channel may include a plurality of signals 140 associated with left (L), right (R), center (C), low frequency effect (LFE), left side (LS), right side (RS) channels, respectively.

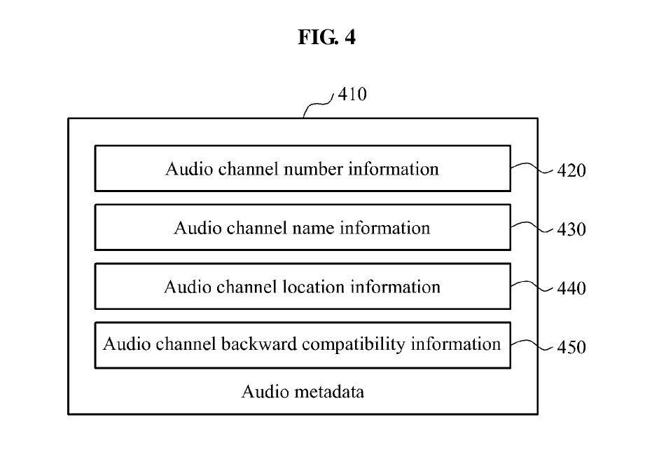

The audio metadata 130 may be additional information for reproducing an audio signal, and include channel information of the raw audio data 120. Further details regarding this will be described in FIG. 4.

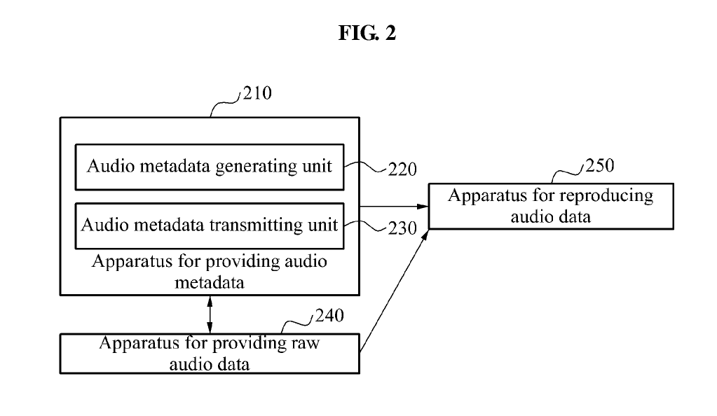

FIG. 2 is a diagram illustrating an operation of an apparatus for providing audio metadata transmitting audio metadata to an apparatus 210 for reproducing audio data according to an embodiment of the present invention.

Referring to FIG. 2, the apparatus for providing the audio metadata 210 may include an audio metadata generating unit 220 and an audio metadata transmitting unit 230.

The audio metadata generating unit 220 may generate audio metadata including channel information of raw audio data. The generated audio metadata may be managed separately from raw audio data, and be coded by the apparatus for providing the audio metadata 210.

The audio metadata transmitting unit 230 may transmit audio metadata to an apparatus for reproducing audio data 250. In another exemplary embodiment, the audio metadata transmitting unit 230 may perform multiplexing of a raw audio channel and audio metadata received from an apparatus 240 for providing raw audio data to transmit the multiplexed raw audio channel and the audio metadata to the apparatus for reproducing the audio data 250. As used herein, “multiplexing” may refer to a method for processing a plurality of signals by combining the plurality of signals to a single signal.

The apparatus for providing the raw audio data 240 may transmit raw audio data in which audio signals are collected for a plurality of channels. The apparatus for providing the audio metadata 210 may generate audio metadata based on the raw audio data in conjunction with the apparatus for providing the raw audio data 240 when necessary.

The apparatus for reproducing the audio data 250 may reproduce raw audio data by analyzing the raw audio data and the audio metadata received. In this instance, the apparatus for reproducing the audio data 250 may reproduce the raw audio data corresponding to channel information, based on audio environment setting information and audio metadata stored in the apparatus for reproducing the audio data 250.

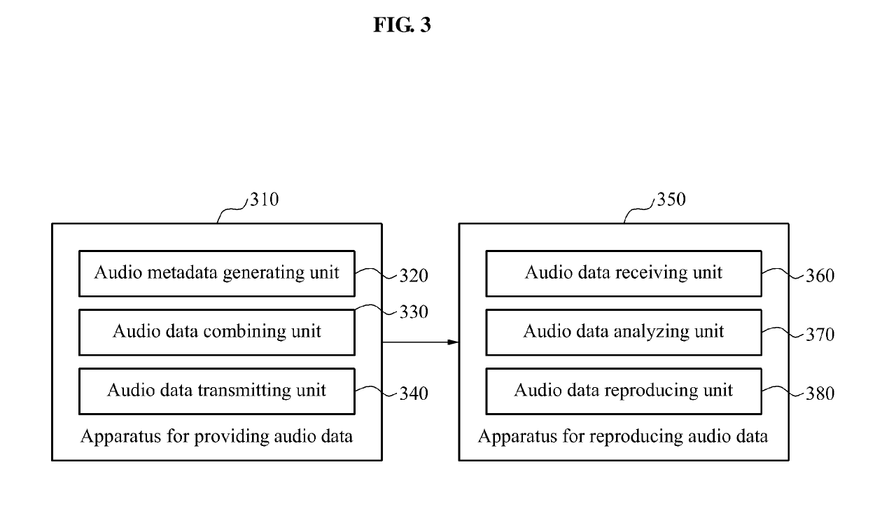

FIG. 3 is a diagram illustrating an operation of an apparatus 310 for providing audio data transmitting audio metadata to an apparatus 350 for reproducing audio data according to an embodiment of the present invention.

Referring to FIG. 3, the apparatus 310 for providing the audio data may include an audio metadata generating unit 320, an audio data combining unit 330, and an audio data transmitting unit 340.

The audio metadata generating unit 320 may generate audio metadata including channel information of raw audio data. In particular, the audio metadata generating unit 320 may analyze the raw audio data, and display channel information of an audio signal as the audio metadata.

The audio data combining unit 330 may combine raw audio data and audio metadata into audio data. The audio data combining unit 330 may perform coding either of the raw audio data or the audio metadata, or perform coding of both the raw audio data and the audio metadata.

The audio data transmitting unit 340 may transmit the combined audio data to the apparatus for reproducing the audio data 350. In particular, the audio data transmitting unit 340 may perform multiplexing of the coded audio data to transmit the multiplexed audio data to the apparatus for reproducing the audio data 350.

The apparatus for reproducing the audio data 350 may include an audio data receiving unit 360, an audio data analyzing unit 370, and an audio data reproducing unit 380.

The audio data receiving unit 360 may receive audio data from the apparatus for providing the audio data 310.

The audio data analyzing unit 370 may analyze raw audio data and audio metadata from the received audio data. The audio data analyzing unit 370 may perform demultiplexing or decoding of the audio data. The audio data analyzing unit 370 may separate the raw audio data and the audio metadata in the audio data through the demultiplexing and the decoding, and extract an audio signal for a plurality of channels from the raw audio data.

In another embodiment of the present invention, the audio data analyzing unit 370 may separate the received audio data into raw audio data and audio metadata, and a user may perform editing or re-configuring of an additional audio signal using the separated raw audio data and the audio metadata.

The audio data reproducing unit 380 may reproduce raw audio data based on the analyzed audio metadata and predetermined audio reproducing setting information. As used herein, the predetermined audio reproducing setting information may be audio environment setting information of an apparatus for reproducing audio, for example, a condition in which speakers are disposed, such as, a home television (TV) system, an audio/video (A/V) receiver, and the like.

The audio data reproducing unit 380 may combine a signal of an audio channel included in raw audio data based on backward compatibility information of audio channel included in audio metadata and change the combined signal of the audio channel to a lower channel when a channel included in audio reproducing setting information is a channel lower than a channel included in raw audio data. The channel included in audio reproducing setting information represents a number of channels that the audio data reproducing unit 380 may reproduce.

For example, when six channels are included in raw audio data, and a number of channels included in audio reproducing setting information are two channels, the audio data reproducing unit 380 may perform down mixing of received audio data to a channel lower in two levels. As used herein, “down mixing” may refer to converting audio data combining a plurality of channels to audio data having a fewer number of channels. Transitively, the apparatus for reproducing the audio data 350 may reproduce audio data through compatibility of channels despite receiving audio data having a greater number of channels included in the audio environment setting information.

The apparatus for reproducing audio data 350 may reproduce audio data irrespective of a number of channels, by selecting not to output a channel absent an audio signal when audio data including a channel lower than a channel included in the audio environment setting information is received.

FIG. 4 is a diagram illustrating a configuration of audio metadata 410 according to an embodiment of the present invention.

Referring to FIG. 4, the audio metadata 410 may include at least one of audio channel number information 420, audio channel name information 430, audio channel location information 440, and audio channel backward compatibility information.

The audio channel number information 420 may be a number of audio signals included in raw audio data. For example, when a 5.1 channel signal is included in the raw audio data, the audio channel number information 420 may have a value of six. When a 7.1 signal is included in the raw audio data, the audio channel number information 420 may have a value of eight. The audio channel number information 420 may refer to an object number of audio signals stored based on an object.

The audio channel name information 430 may refer to a channel name for a plurality of audio signals included in the raw audio data. For example, in a case of a 5.1 channel signal, the audio channel name information 430 may include (L, R, C, LFE, LS, RS) information. In particular, an audio signal stored in the raw audio data may correspond to a name of (L, R, C, LFE, LS, RS) in a sequential order. A definition of an audio channel name and an audio signal order is not mandatory, however, may be predetermined by a manufacturer. Nonetheless, a 5.1 channel signal and a 2.0 channel signal may be unified in the same form such as (L, R, C, LFE, LS, RS), (LR), respectively, to be compatible with an existing system.

The audio channel location information 440 may refer to a location at which an audio signal channel is to be disposed spatially. The audio channel location information 440 may include horizontal azimuth information and vertical azimuth information.

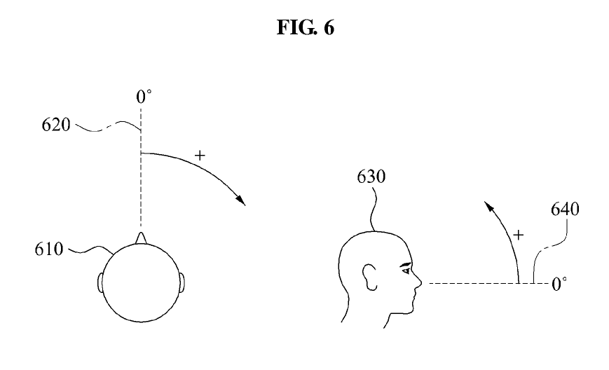

A horizontal azimuth may set a front direction to be a reference point at zero degrees 620, and set a clockwise direction to be (+), based on a surface horizontal to a ground surface when a user 610 faces front as shown in FIG. 6. A vertical azimuth may set a front direction to be a reference point at zero degrees 640, and set an upward direction to be (+) based on a surface vertical to a ground surface when a user 630 faces forward as shown in FIG. 6.

For example, in a case of a 2.0 channel, when audio channel name information 430 may be represented as (L, R), and audio channel location information 440 may be represented as [(330, 0), (30, 0)], L channel may be disposed at “330” degrees to horizontal, “0” degree to vertical, and R channel may be disposed at “30” degrees to horizontal, and “0” degree to vertical. A null sign may be used to indicate that a location of a disposition is undetermined, and an azimuth may be represented as (null, null).

The audio channel backward compatibility information 450 may refer to information on combining a signal of an audio channel included in raw audio data and changing the combined signal to a lower channel. For example, the backward compatibility information 450 may indicate a degree of capability of raw audio data including a 7.1 channel signal with a 5.1 channel signal or a 2.0 channel signal. Audio data including a greater number of channels than the 5.1 channel signal may include information on changing to the 5.1 channel signal or the 2.0 channel signal, and the audio data including the 5.1 channel signal may include information on compatibility with the 2.0 channel signal.

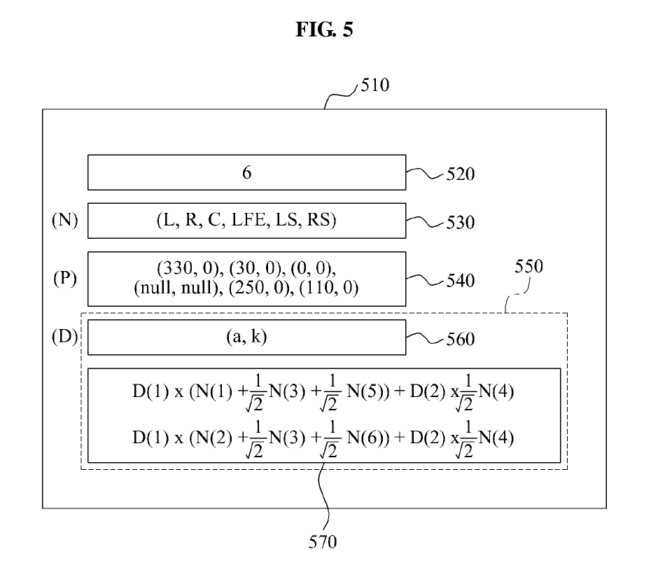

FIG. 5 is a diagram illustrating an example of an audio metadata configuration according to an embodiment of the present invention.

Referring to FIG. 5, audio metadata 510 may include audio channel number information 520, audio channel name information 530, audio channel location information 540, and audio channel backward compatibility information 550.

A value of the audio channel number information 520 being “6” may indicate a 5.1 channel in which a number of channels of raw audio data may be “6”, and a number of LFE channels may be “1”. Based on the audio channel name information 530, a name of a plurality of channels of audio signals included in the raw audio data may be L, R, C, LFE, LS, RS in a sequential order.

Based on the audio channel location information 540, L channel being (330, 0) may be disposed at “330” degrees to horizontal, and “0” degrees to vertical, and R channel being (30, 0) may be disposed at “30” degrees to horizontal, and “0” degrees to vertical. C channel being (0, 0) may be disposed at “0” degrees to horizontal, and “0” degrees to vertical, and LS channel being (250, 0) may be disposed at “250” degrees to horizontal, and “0” degrees to vertical. RS channel being (110, 0) may be disposed at “110” degrees to horizontal, and “0” degrees to vertical, and LFE channel being (null, null) may be disposed at any location. Audio channel location information of the 5.1 channel and the 2.0 channel may have values of [(330, 0), (30, 0), (0, 0), (null, null), (250, 0), (110, 0)], [(330, 0), (30, 0)] for compatibility with an existing system.

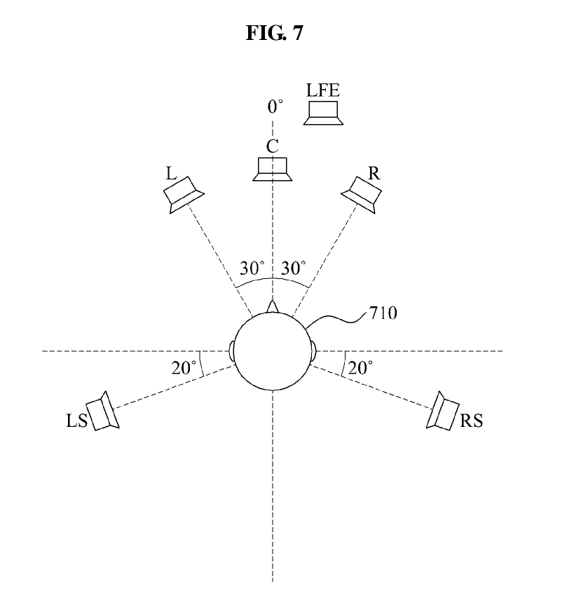

An implementation of audio channel location information is shown in FIG. 7.

FIG. 7 is a diagram illustrating speakers being disposed in space based on audio channel location information according to an embodiment of the present invention.

Referring to FIG. 7, a speaker may be located at a position at which a plurality of channels is disposed, centered based on a user 710. FIG. 7 illustrates multi channel audio data based on information included in audio metadata, and using the audio metadata, the multi channel audio data including a greater number of channels than a 5.1 channel may be implemented in various manners.

In FIG. 5, the audio channel backward compatibility information 550 may indicate a constant 560 and calculation information 570 for down mixing from the 5.1 channel signal to a 2.0 channel signal. A constant (a, k) 560 may be a predetermined constant created by an audio data producer, and the calculation information 570 may be stored based on a backward channel sequential order. In the calculation information 570, D(1) denotes first data “a” of (D), and D(2) denotes second data “k” of (D). N(1) denotes an L channel signal as first data of (N), and N(2) denotes an R channel signal as second data of (N). N(3) denotes a C channel signal, N(4) denotes an LFE channel signal, N(5) denotes an LS channel signal, and N(6) denotes an RS channel signal. In particular, the audio channel backward compatibility information 550 may store down mixing information as shown in Table 1. The preceding embodiment is provided as an example of down mixing from the 5.1 channel signal to the 2.0 channel signal described herein. Accordingly, various changes, modifications, and equivalents of the methods, apparatuses, and/or systems described herein will be suggested to those of ordinary skill in the art.

TABLE 1

| | Channel matrixing |
|---|---|
| Channel layout | (a and k are predetermined constants) |
| 5.1 → 2.0 | |
| 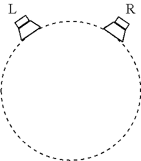 | $\begin{matrix}L = a * ( L + \frac{1}{\sqrt{2}} C + \frac{1}{\sqrt{2}} LS ) + k * \frac{1}{\sqrt{2}} LFE \\ R = a * ( R + \frac{1}{\sqrt{2}} C + \frac{1}{\sqrt{2}} RS ) + k * \frac{1}{\sqrt{2}} LFE\end{matrix}$ |

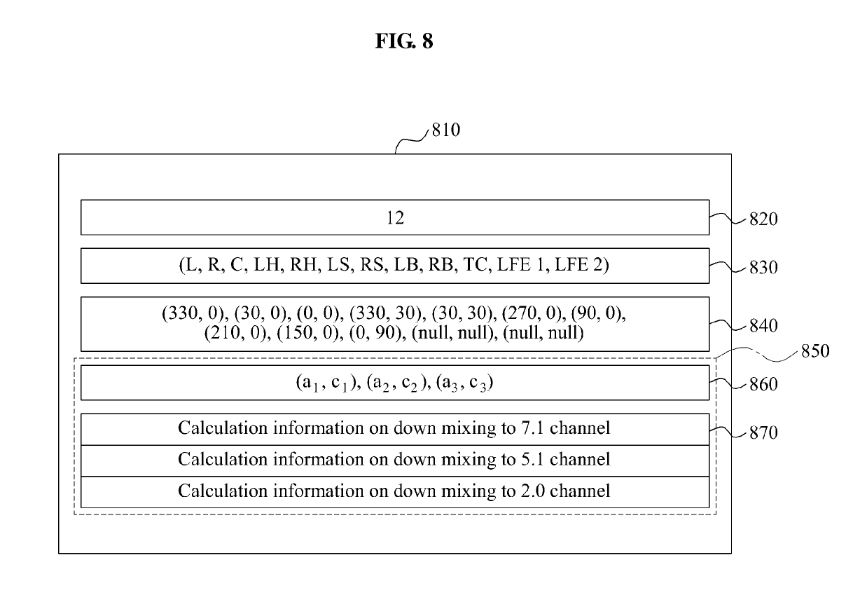

FIG. 8 is a diagram illustrating another embodiment of an audio metadata configuration according to an embodiment of the present invention.

Referring to FIG. 8, audio metadata 810 may include audio channel number information 820, audio channel name information 830, audio channel location information 840, and audio channel backward compatibility information 850 for three channels.

A value of the audio channel number information 820 being “12” may indicate a 10.2 channel in which a number of raw audio data channels is “12”, and a number of LFE channels is “2”. Based on the audio channel name information 830, a name of a plurality of channels of audio signals included in the raw audio data may be L, R, C, LH, RH, LS, RS, LB, RB, TC, LFE1, and LFE2 in a sequential order.

Based on the audio channel location information 840, L channel being (330, 0) may be disposed at “330” degrees to horizontal, and “0” degrees to vertical, R channel being (30, 0) may be disposed at “30” degrees to horizontal, and “0” degrees to vertical, and C channel being (0, 0) may be disposed at “0” degrees to horizontal, and “0” degrees to vertical. LH channel being (330, 30) may be disposed at “330” degrees to horizontal, and “30” degrees to vertical, RH channel being (30, 30) may be disposed at “30” degrees to horizontal and “30” degrees to vertical, and LS channel being (270, 0) may be disposed at “270” degrees to horizontal, and “0” degrees to vertical. Also, RS channel being (90, 0) may be disposed at “90” degrees and “0” degrees to vertical, LB channel being (210, 0) may be disposed at “210” to horizontal and “0” degrees to vertical, and RB channel being (150, 0) may be disposed at “150” degrees to horizontal and “0” degrees to vertical. Further, TC channel being (0, 90) may be disposed at “0” degrees and “90” degrees to vertical, LFE1 channel and LFE2 channel being null may be disposed at any locations. Accordingly, since the audio metadata 810 may include audio channel information on a horizontal place and on a layer higher than a horizontal plane, an audio producer may configure a three-dimensional (3D) sound system.

Based on the audio channel backward compatibility information 850, 10.2 channel signal may indicate constants 860 and a calculation information 870 for down mixing from a 10.2 channel signal to a 7.1 channel signal, a 5.1 channel signal, and a 2.0 channel signal. The constants 860 (a1, c1), (a2, c2) (a3, c3) may be predetermined constants created by an audio producer, and calculation information 870 may be stored based on a backward channel order. Information on combination and conversion of signals for changing to a plurality of channels from a 10.2 channel signal may include plurality of calculation information 870 for down mixing. Accordingly, although an apparatus for reproducing audio data may receive audio data including a 10.2 channel signal, the audio data may be reproduced by being made compatible with a channel configuration of the apparatus for reproducing the audio. The order of the calculation information 870 being stored may be predetermined by a producer, and is not limited to the embodiment in the foregoing.

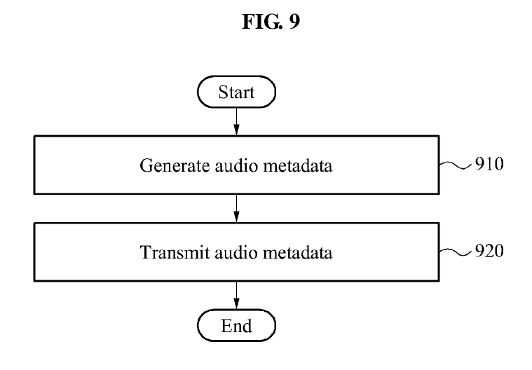

FIG. 9 is a flowchart illustrating an operation in which an apparatus for providing audio metadata provides audio metadata according to an embodiment of the present invention.

In operation 910, the apparatus for providing the audio metadata may generate audio metadata including information on raw audio data. The audio metadata generated by the apparatus for providing the audio metadata may be managed separately from raw audio data, and may be coded by the apparatus for providing the audio metadata.

In operation 920, the apparatus for providing the audio metadata may transmit the generated audio metadata to an apparatus for reproducing audio data. In another embodiment, the apparatus for providing the audio metadata may perform multiplexing of raw audio data and audio metadata received from an apparatus for providing raw audio data and transmit the multiplexed raw audio data and the audio metadata to the apparatus for reproducing the audio data.

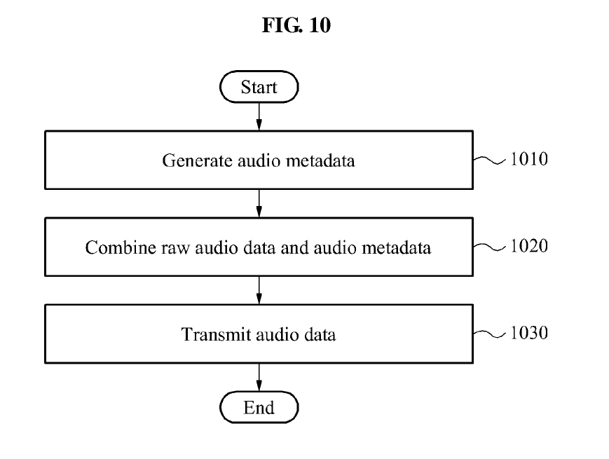

FIG. 10 is a flowchart illustrating an operation in which an apparatus for providing audio data provides audio data according to an embodiment of the present invention.

In operation 1010, the apparatus for providing the audio data may generate audio metadata including information on raw audio data. In particular, based on the raw audio data, the apparatus for providing the audio data may represent information on an audio signal as audio metadata.

In operation 1020, the apparatus for providing the audio data may combine the raw audio data and the generated audio metadata to audio data. In this instance, the apparatus for providing the audio data may code raw audio data and audio metadata separately, or code the raw audio data along with the audio metadata.

In operation 1030, the apparatus for providing the audio data may transmit the combined audio data to an apparatus for reproducing audio data. The apparatus for providing the audio data may perform multiplexing of the coded audio data, and transmit the multiplexed coded audio data to the apparatus for reproducing the audio data.

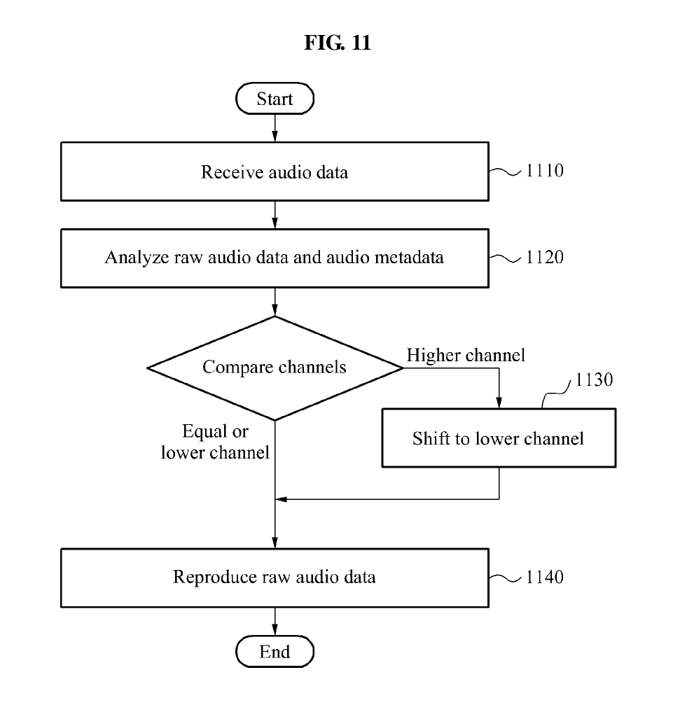

FIG. 11 is a flowchart illustrating an operation in which an apparatus for reproducing audio data reproduces audio data according to an embodiment of the present invention.

In operation 1110, the apparatus for reproducing the audio data may receive audio data from an apparatus for providing audio data.

In operation 1120, the apparatus for reproducing the audio data may analyze raw audio data and audio metadata from the received audio data. The apparatus for reproducing the audio data may perform demultiplexing or decoding of the audio data. The apparatus for reproducing the audio data may analyze raw audio data and audio metadata from the audio data through demultiplexing and decoding, and an audio signal for a plurality of channels may be extracted from the raw audio data.

According to another embodiment of the present invention, the apparatus for reproducing the audio data may separate the received audio data into raw audio data and audio metadata, and a user may edit or reconfigure an additional audio signal using the separated raw audio data and the audio metadata.

In operation 1130, when a channel included in audio reproducing setting information is a channel lower than a channel included in the raw audio data, the apparatus for reproducing the audio data may combine a signal of an audio channel included in the raw audio data based on audio channel backward compatibility information included in the audio metadata, and change the combined signal to a lower channel.

In operation 1140, the apparatus for reproducing the audio data may reproduce the raw audio data based on the analyzed audio metadata and predetermined audio reproducing setting information, when a channel included in the audio reproducing setting information is a channel equal to or higher than a channel included in the raw audio data. Also, the apparatus for reproducing the audio data may reproduce the raw audio data that is changed to the lower channel.

According to embodiments of the present invention, it is possible to generate audio metadata including channel information of raw audio data, and transmit the generated audio metadata to an apparatus for reproducing audio data.

According to embodiments of the present invention, it is possible to combine raw audio data and audio metadata including raw audio data channel information, and output multi-channel audio in various manners by transmitting the combined raw audio data and the audio metadata to an apparatus for reproducing audio data.

According to embodiments of the present invention, it is possible to reproduce raw audio data based on audio metadata by demultiplexing or decoding audio data received from an apparatus for providing audio data.

According to embodiments of the present invention, it is possible to enable a channel compatibility through combining a signal of an audio channel included in raw audio data when a channel included in audio reproducing setting information is a lower channel than a channel included in the raw audio data.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for providing audio metadata, the apparatus comprising:
an audio metadata generating unit to generate audio metadata including channel information of raw audio data; and
an audio metadata transmitting unit to transmit the generated audio metadata to an apparatus for reproducing audio data.

2. The apparatus of claim 1, wherein the audio metadata comprises at least one of audio channel number information, audio channel name information, audio channel location information, and audio channel backward compatibility information.

3. The apparatus of claim 2, wherein the audio channel number information is a number of audio signals included in raw audio data.

4. The apparatus of claim 2, wherein the audio channel location information is information on a location at which an audio signal channel is to be disposed spatially.

5. The apparatus of claim 4, wherein the audio channel location information is configured by horizontal azimuth information and vertical azimuth information.

6. The apparatus of claim 2, wherein the audio channel name information is a channel name for a plurality of audio signals included in the raw audio data.

7. The apparatus of claim 2, wherein the audio channel backward compatibility information combines a signal of an audio channel included in the raw audio data, and changes the combined signal to a lower channel.

8. An apparatus for providing audio data, the apparatus comprising:
an audio metadata generating unit to generate audio metadata including channel information of raw audio data;
an audio data combining unit to combine the raw audio data and the generated audio metadata to audio data and
an audio data transmitting unit to transmit the combined audio data to an apparatus for reproducing audio data.

9. The apparatus of claim 8, wherein the audio metadata comprises at least one of audio channel number information, audio channel name information, audio channel location information, and audio channel backward compatibility information.

10. An apparatus for reproducing audio data, the apparatus comprising:
an audio data receiving unit to receive audio data from an apparatus for providing audio data;
an audio data analyzing unit to analyze raw audio data and audio metadata from the received audio data; and
an audio data reproducing unit to reproduce the raw audio data based on the analyzed audio metadata and predetermined audio reproducing setting information.

11. The apparatus of claim 10, wherein the audio metadata comprises at least one of audio channel number information, audio channel name information, audio channel location information, and audio channel backward compatibility information.

12. The apparatus of claim 10, wherein the audio data analyzing unit demultiplexes or decodes the received audio data.

13. The apparatus of claim 10, wherein the audio data reproducing unit combines a signal of an audio channel included in the raw audio data based on audio channel backward compatibility information included in audio metadata when a channel included in the audio reproducing setting information is a channel lower than a channel included in the raw audio data.

14. A method for providing audio metadata, the method comprising:
generating audio metadata including channel information of raw audio data; and
transmitting the generated audio metadata to an apparatus for reproducing audio data.

15. The method of claim 14, wherein the audio metadata comprises at least one of audio channel number information, audio channel name information, audio channel location information, and audio channel backward compatibility information.

16. A method for providing audio data, the method comprising:
generating audio metadata including channel information of raw audio data;
combining the raw audio data and the generated audio metadata to audio data; and
transmitting the combined audio data to an apparatus for reproducing audio data.

17. The method of claim 16, wherein the audio metadata comprises at least one of audio channel number information, audio channel name information, audio channel location information, and audio channel backward compatibility information.

18. A method for reproducing audio data, the method comprising:
receiving audio data from an apparatus for providing audio data;
analyzing raw audio data and audio metadata from the received audio data; and
reproducing the raw audio data based on the analyzed audio metadata and predetermined audio reproducing setting information.

19. The method of claim 18, wherein the audio metadata comprises at least one of audio channel number information, audio channel name information, audio channel location information, and audio channel backward compatibility information.

20. The method of claim 18, wherein the reproducing of the raw audio data comprises combining a signal of an audio channel included in raw audio data based on audio channel backward compatibility information included in audio metadata when a channel included in the audio reproducing setting information is a channel lower than a channel included in raw audio data.
